(19) United States
(12) Patent Application Publication
(10) Pub. No.: US 2020/0210503 A1
(43) Pub. Date: Jul. 2, 2020

(54) MEMBER ACTIVITY BASED PROFILE VIEWING EVALUATION SYSTEM

(71) Applicant: Microsoft Technology Licensing, LLC, Redmond, WA (US)

(72) Inventors: Cissy Chen, San Francisco, CA (US); Weiguang Shi, Foster City, CA (US); Xiaoyu Lai, Milpitas, CA (US); Gaurav Vijayvargiya, Santa Clara, CA (US); Diya Dutt Sharma, San Francisco, CA (US); Marcos Vinicius Vieria Santanna, Campbell, CA (US); Wei Wang, Beijing (CN); Richard Cook, San Jose, CA (US); Xinheng Gong, Sunnyvale, CA (US)

(21) Appl. No.: 16/233,328

(22) Filed: Dec. 27, 2018

(51) Int. Cl. G06F 16/9535; G06F 16/9538

(52) U.S. Cl. CPC G06F 16/9535; G06F 16/9538

(57) ABSTRACT

Systems and techniques for a member activity based profile viewing evaluation system are described herein. In an example, a profile viewing evaluation system is adapted to receive a viewed profile event indicating a member profile was accessed by a viewer, wherein the viewed profile event includes a member identification associated the member profile and a viewer identification associated with the viewer. The profile viewing evaluation system may obtain activity data related to activities performed by the member on the online service. The profile viewing evaluation system may obtain attributes of the viewer. The profile viewing evaluation system may determine the viewer is a notable viewer by comparing the attributes of the viewer to the activity data of the member. The profile viewing evaluation system may generate a graphical user interface to display viewer identification information associated with viewers of the member profile, including viewers classified as notable viewers.

### TECHNICAL FIELD

Embodiments described herein generally relate to optimizing the information presented to a member of an online service.

### BACKGROUND

An online community, such as an online service, includes many members. Each member may have a profile which is viewable by other members of the service. The community or service may provide functionality for a member to see which other members have viewed their profile. However, this functionality does not assist or alert the member of which viewers may have relevance to the member.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a graphical user interface (GUI) for displaying notable viewers for a social networking service, in accordance with some embodiments.

FIG. 2 illustrates an example of a process to determine a notable viewer and present the notable viewer on a device, in accordance with some embodiments.

FIG. 3 illustrates an example of the notable viewer determination process, in accordance with some embodiments.

FIG. 4 illustrates an example of the process of providing notable viewer data to a computing device for a member, in accordance with some embodiments.

FIG. 5 illustrates a flowchart showing a technique for determining a notable viewer of a member profile in a social networking service, in accordance with some embodiments.

FIG. 6 is a block diagram showing the functional components of a social networking service.

FIG. 7 is a block diagram illustrating an example of a machine upon which one or more embodiments may be implemented.

### DETAILED DESCRIPTION

An online service, such as a social networking service may provide functionality for a member to see a history of members which have viewed the member's profile. This may apply to both individuals and organizations. Some social networking services are a means for people to promote themselves. This may be to help them find a job or attract those interested in their work, such as a celebrity or journalist. Thus, it is beneficial to a member to know which members of the social networking service are viewing their profile to then determine if the member's promotion is attracting the desired followers. In the case of the job seeker, they may choose to alter their profile if those that are viewing their profile are not in the field desired by the job seeker.

While the information of which members have viewed a profile may be helpful to the member, a simple index of this information may not assist the member in their desired goals if there is a breadth of unfocused data (e.g., hundreds or thousands of different profile views). The member may miss opportunities if the member is not presented with, or alerted to, relevant viewer information. Furthermore, the member's profile may receive many false positive views. For example, if the member happens to have a very common name or have a name similar to a famous person, then the profile may be viewed by many people, but very few of them may have any relevance to the member.

Disclosed in some examples are methods, systems, and machine-readable media which determine which viewers of a member's profile are notable to the member. Providing information about who is viewing a member profile may be valuable information to a member, whether the member is a person or an organization. However, the viewer information loses its value if the member does not know why the viewer information may be relevant to the member. Further, if there is an abundance of viewer information, the member may not be able to discern the relevant viewer information from the irrelevant viewer information. By indicating to the member the viewer information which is notable, the member may benefit from the viewer information and use it to their advantage, whether seeking employment, attempting to grow a business, or make networking connections. In addition to indicating which viewers are notable, by providing information about why the viewer is notable to the member, the member has information available to reach out to the viewer and make a connection.

Identifying a profile viewer as notable improves the usability of the social network service for the member such that viewer information that is relevant to the member is identified and highlighted for the member. By bringing notable viewers to the attention of the member, the efficiency of the user interface is improved for the member. Instead of requiring the member to sort through a long list of profiles with no order or preference or importance, with the member then having to determine if each viewer has a relevance to them, and specifically an important relevance, the identified notable viewers presents an efficient and usable system for the member. This additionally creates a technical improvement to the social networking service. With a simple index of profile viewers, a member may have to view information about each viewer to determine relevance for the viewer, thus requiring a database access to get the information for each viewer. Identifying the notable viewers and the reasons a viewer is considered notable presents the information the member would otherwise have to seek out and thus reduces the processing and database accesses to get the member the information desired.

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business networking service. A social networking service is an online service, platform or site that allows members to build or reflect social networks or social relations among members. Typically, members construct profiles, which may include personal information such as name, contact information, employment information, photographs, personal messages, status information, links to web-related content, blogs, and so on. Typically, only a portion of a member's profile may be viewed by the general public, and/or other members.

In the context of a business networking service (a type of social networking service), a person may establish a link or connection with his or her business contacts, including work colleagues, clients, customers, and so on. Further, a person may choose to follow a company or organization to stay up-to-date with the actions of that company or organization. An organization may be a company or corporation, a non-profit organization, a political group, or any other type of association or business. With a social networking service, a person may establish links or connections with his or her friends and family. A connection is generally formed using an invitation process in which one member “invites” a second member to form a link. The second member then has the option of accepting or declining the invitation. In some examples, some social networking services operate on a subscription or following basis, where one member follows another without mutual agreement. For example, Twitter, a micro-blogging service allows members to follow other members without explicit permission.

In general, a connection or link represents or is otherwise associated with an information access privilege, such that a first person who has established a connection with a second person is, via the establishment of that connection, authorizing the second person to view or access non-publicly available portions of their profiles. Of course, depending on the particular implementation of the business/social networking service, the nature and type of the information that may be shared, as well as the granularity with which the access privileges may be defined to protect certain types of data may vary greatly.

Social and business networking services may expand their services beyond members making business connections. This may include providing companies or entrepreneurs a platform to promote their company to members which have chosen to follow the company. The social networking service may provide a job listing service for companies to post open job positions and members of the business networking service may apply to the open job positions.

A notable viewer of a member profile may be determined based on their relevance to the member. For example, general relevance of the viewer may include attributes such as working at the same company that the member follows or being connected to some of the same people as the member. More specific relevant attributes may include working for a company which the member recently applied for a job. Determining further attributes, such as the viewer being a hiring manager at the company the member recently applied for a job increases the relevance and notability of the viewer. The more attributes which may be determined about the viewer may increase their notability, such as determining the viewer is a hiring manager in the same department as the applied for job or working in a field associated with other positions or interests of the member. Time may be a factor in determining notability, both from a perspective of how recently the activities of the member relate to the viewer and how recently the viewer viewed the profile of the member.

In some examples, notability may be based on relevance to the member and not based upon prestige of the viewer. In other examples, notability may be based upon both prestige of the viewer and relevance to the member. For example, a member profile may be viewed by a high-profile person, such as the president of a large software company. While the member may feel honored that the software company president chose to view his profile, it may have been a mistake, such as a common name or accidental click selection on a web page. If the member has no real reason for being contacted by software company president, such as being a florist in a small town, then the likelihood of mistake is greater. Thus, notability is determined based on the relevance to the member. Having a profile viewed by a prestigious person such as a software company president or famous actor may be exciting, but is not notable as it may be a mistake if there is not any determinable relevance to the member.

The notable determination improves the usability of the social network service to the user so that relevant viewer information is presented to the member. Otherwise, by presenting viewer information based on the data of the viewers may present data of mistakes and give the member irrelevant information, and possibly result in the member not being presented with relevant and beneficial viewer information. For example, in the case of the small town florist, their profile may be viewed by the software company president and an event planner for the local hotel. As an example, a system that determines viewer presentation based only on the prestige and attributes of the viewer, then the software company president may be presented as the most significant viewer of the florist's profile, when the profile view by the software company president may have been a mistake as the florist and the president have no notable commonalities. Whereas, the event planner, who does not have same status as the software company president, is relevant to the florist and presents an opportunity for the florist as they are located in the same town and the florist may follow the local hotel on the social networking service.

When presented with notable viewers, the member may be provided with options to reach out to a notable viewer. This may include a message through the social networking service, an option to connect to the viewer through the social networking service, sending an email, sending a Short Message Service (SMS) message, or placing a phone call to the viewer. The member may be provided with information about the notable viewer, specifically information about how the viewer relates to the member and why the viewer was determined to be notable. The notable viewer information may be used to generate a message for the member to send to the notable viewer. For example, the message may introduce the member and explain that the member was interested in speaking with the notable viewer because the notable viewer works at a company where the member recently applied for a job.

Attributes used to determine if a viewer is notable may be any attribute which shares relative commonality or interest with the member. This may include being located in the same geographic location or having similar friends on the social networking service. If the member is currently seeking employment and has applied for positions through the social networking service, there may be different types of viewers which would qualify as having varying degrees of notability. This may include senior leaders in the industry (or similarly related industry) the member works in or wants to work in. This may include viewers with a close relation to a position applied for by the member, such as the person who posted the job that was applied for, the recruiter for the job that was applied for, the hiring manager for the job that was applied for, and people who work at the same company as the job that was applied for. The social networking service may evaluate the candidates which have applied for the position and determine if the member is a top applicant for the position. If the member is determined to be a top applicant for a position, then the notable viewers related to that position may be highlighted to the member.

The social networking service may further determine notable viewers based on positions the member may be interested in. This includes viewers that posted on the social networking service a position of interest for the member, a recruiter for a position of interest for the member, and a hiring manager for a position of interest for the user. Notable viewers may include recruiters, hiring managers, and job connectors at fast growing companies related to the member's current job title.

For each viewer of a member profile, a score may be calculated to determine if the viewer qualifies as a notable viewer. In an embodiment, if the score exceeds a predetermined threshold value, the viewer may be considered a notable viewer. The score may be used to rank the notable viewers for presentation to the member. For example, the notable viewer with the highest score may be listed first among all notable viewers.

The score may be based on multiple factors and may use weights for factors that are considered most relevant to the member. For example, a viewer that lives in the same locality as the member or is employed at a company the member follows may be low weighted factors. A viewer that works in the same department of a company the member recently applied for a job may be a medium weighted factor. A viewer that is the hiring manager or recruiter for a position the member applied for may be highly weighted factors.

The member may customize how profile viewers are scored such that the viewers which are classified as notable, are notable for reasons which are relevant to the member. For example, if the member is interested in making social connections, the member may customize the scoring such that viewers who attended the same high school or college as the member have a higher weighted score. In contrast, a member that is seeking employment may customer the scoring such that viewers associated with a job posting have a higher weighted score.

A score for a viewer may be based on multiple factors of how the viewer relates to the member. Each of these factors may be weighted differently. Using the example of a member who has applied for a job, a viewer that is a hiring manager for that job would be a highly weighted factor. Contributing further to the score may be that the viewer and the member attended the same college, but not weighted has heavily as the hiring manager factor. Another viewer that has factor of working at the same company and department as the job may weight those factors less heavily as the viewer does not have a direct relation to the job.

Factors and their weights may be dependent upon the type of social networking service and what may be considered relevant to a member of the social networking service. For example, the social networking service may be for people that enjoy making crafts. A member who does craft work with yarn may be a notable viewer to a member that makes handmade knitting needles.

Factors which are determined to be most important or most relevant, such as those that are highly weighted factors may be distinguished to the member. For example, in the presentation of notable viewers, if a notable viewer is the hiring manager for a position the member recently applied for, then the profile presented of the notable viewer may list the factors which contributed to the viewer being considered notable. Among the listed factors, the hiring manger factor may be highlighted to distinguish the factor for the member.

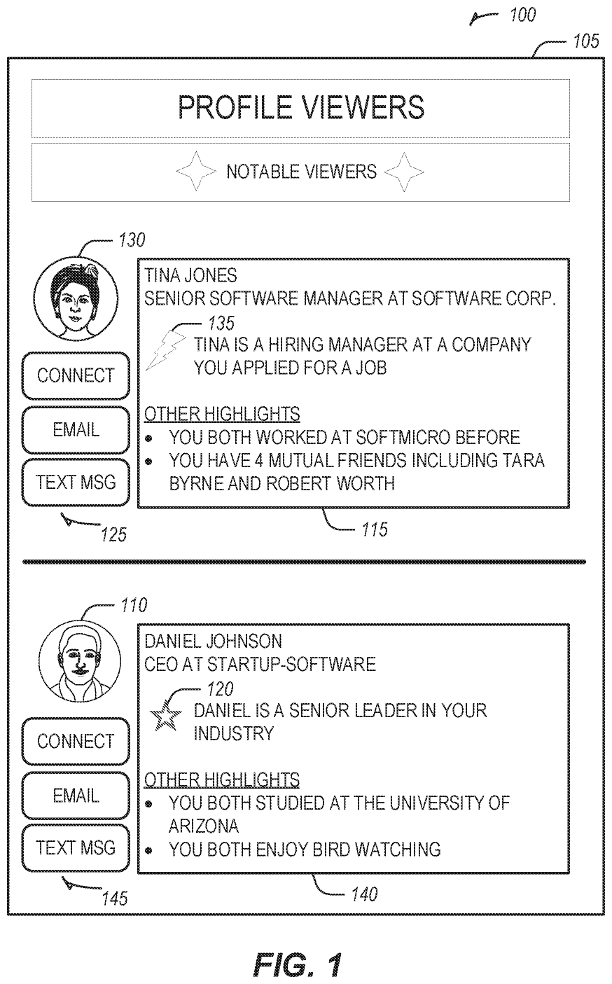

FIG. 1 illustrates an example of a graphical user interface (GUI) 100 for displaying notable viewers for a social networking service, in accordance with some embodiments. The GUI 100 may display a profile viewer page 105 which lists all of the people that have viewed the profile of the member. The social networking service may limit the viewers that the member may see based on the status of the member. For example, the social networking service may require the member to pay a fee to have access to tools such as information about profile viewers. The example GUI 100 displays profile viewer page 105 which have been distinguished as notable viewers.

The notable viewers on the profile viewer page 105 may include a picture 110 and picture 130 of the notable viewer and viewer information 115 and viewer information 140. The viewer information 115 and viewer information 140 may include general information about the viewer such as their name and their current position at the company at which they are employed. The viewer information 115 and viewer information 140 may include the reason the viewer is considered a notable viewer, such as being a hiring manager at the same company the member applied for a job or a leader in the industry of the member. The notable reason may be decorated, such as with a star 120 and bolt 135, to call out the importance of the notable viewer to the member. In the example 100, each notable viewer has a single notable reason decorated with a star 120 or bolt 135, however, a notable viewer profile may include multiple notable reasons which are decorated or highlighted for the member. The number of decorated or highlighted notable reasons may be determined by scoring each of the notable reasons and selecting those that exceed a threshold for highlighting or decoration. The viewer information 115 and viewer information 140 may include additional information about the viewer, such as attributes the member and viewer have in common. This information may be used to facilitate a conversation or connection.

The profile viewer page 105 may include connection buttons 125 and connection buttons 145 to assist the member in connecting with the viewer. The connection buttons 125 and connection buttons 145 may include actions such as connecting over the social networking service, emailing the viewer, or sending a text message to the viewer. The actions associated with the connection buttons 125 and connection buttons 145 may include pre-generated communications to assist the member in making a connection with the viewer. For example, if the member chooses to email the viewer, email text may be generated with a greeting including the viewers name and a description of the commonalities between the viewer and the member. The member may further edit the email before sending it to the viewer.

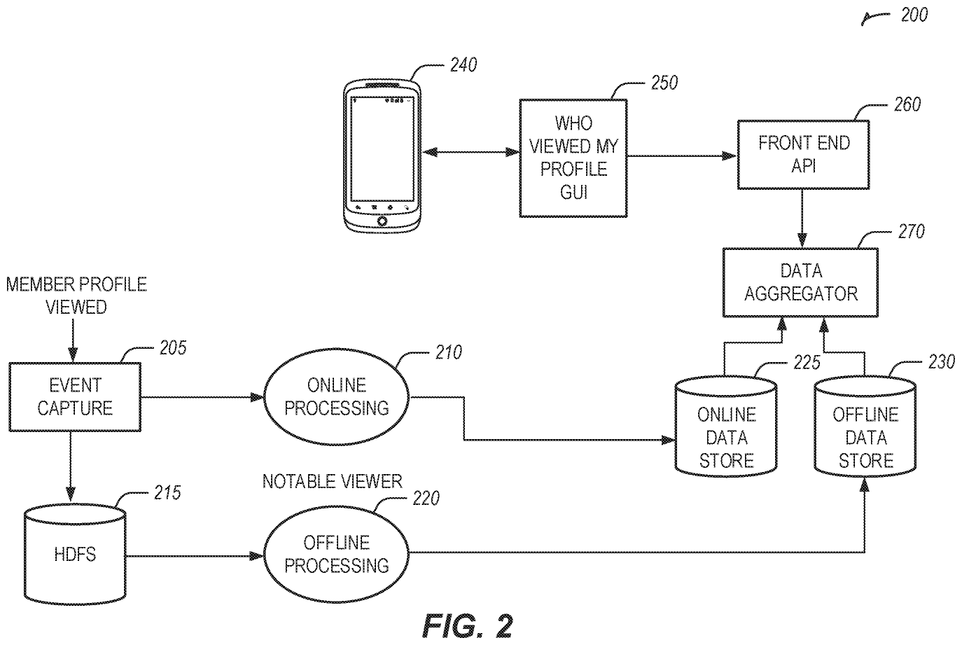

FIG. 2 illustrates an example of the process 200 to determine a notable viewer and present the notable viewer on a device, in accordance with some embodiments. The social networking service may capture events that occur between members of the social networking service, such as when two members connect. The process 200 includes an event capture queue 205, which for the present process 20( )receives an event that a member profile was viewed. This event includes at least the identification of the member profile that was viewed and the identification of the member that was viewing the profile. The event is then immediately sent to online processing 210 to determine if the viewer is a notable viewer. Online processing 210 determines if the viewer is notable and other notable characteristics about the viewer, such as commonalities between the viewer and the member. The notable viewer data determined from online processing 210 is stored in the online data store 225.

The event capture queue 205 also sends the event to a Hadoop distributed file system (HDFS) 215 where the event is stored for later processing. At a later point in time offline processing 220 occurs by pulling viewer event data from the HDFS 215 to determine if the viewer is a notable viewer. Offline processing 220 determines if the viewer is notable and other notable characteristics about the viewer, such as commonalities between the viewer and the member. The notable viewer data determined from offline processing 220 is stored in the offline data store 230.

The online processing 210 with the online data store 225 is used for immediate or short-term results. A social networking service may process a large number of events. The immediate online processing 210 and storage in an online data store 225 provides data results such that if a member were to check who has viewed their profile, then real time notable viewer data may be presented to the member. Because of the significant number of events which are processed, this data may only be stored for a limited amount of time. Thus, the HDFS 215, offline processing 220, and offline data store 230 are used for long term storage of notable viewers.

A member may access the social networking service through a computing device 240. The member may request, using the GUI 250 of computing device 240, a the listing of the viewers of the profile of the member. The profile viewer request goes through a front-end application programming interface (API) 260 to a data aggregator 270. The data aggregator 270 collects the notable viewer data from the online data store 225 and the offline datastore 230 for presentation in the GUI 250.

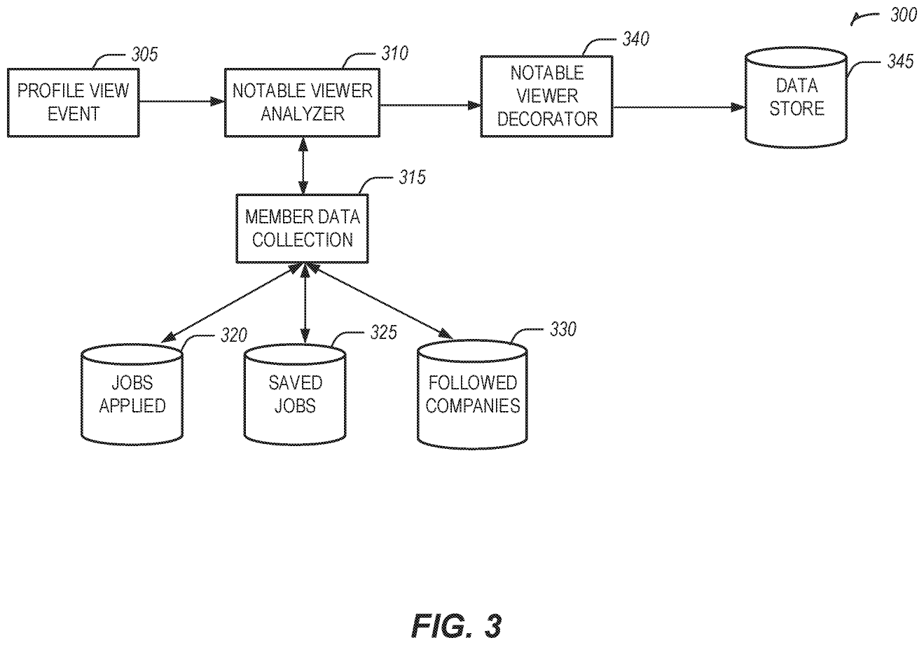

FIG. 3 illustrates an example of the notable viewer determination process 300, in accordance with some embodiments. Process 300 may be the determination process which occurs with online processing 210 and offline processing 220 of FIG. 2. In process 300, a profile view event 305 occurs. The data from profile view event 305 is sent to the notable viewer analyzer 310 to determine if the viewer associated with the profile view event 305 is a notable viewer.

The notable viewer analyzer 310 provides an identification for the member associated with the viewed profile to the member data collection 315. Using the identifier, the member data collection 315 collects activity data about the member from different storage sources. These sources may include, but are not limited to, a data source 320 for jobs the member has applied for, a data source 325 for jobs the member has saved, and a data source 330 for companies the member follows on the social networking service. The member data collection 315 collects member activity data from the data sources and passes the data to the notable viewer analyzer 310. The notable viewer analyzer 310 compares the member activity data to the viewer information to determine if the viewer is a notable viewer. The determination may be based on multiple attributes of the viewer and may use a scoring calculation, as described above.

If the viewer is determined to be a notable viewer by the notable viewer analyzer 310, then the viewer information is sent to the notable viewer decorator 340. The notable viewer decorator 340 determines if any of the attributes about the viewer should be highlighted or have callout images such as a star or a lightbulb. Where the decorations appear may be determined by the member. For example, if the member is particularly interested in a job at Company X and has applied for the job at Company X, the member may configure the decoration settings so that a star appears next to a notable viewer that works for Company X. When the member views the notable viewers, then the member may be immediately informed that their profile was viewed by an employee of Company X. After the notable viewer decorator 340 adds the highlights and decorations to the notable viewer information, the notable viewer information is stored in data store 345.

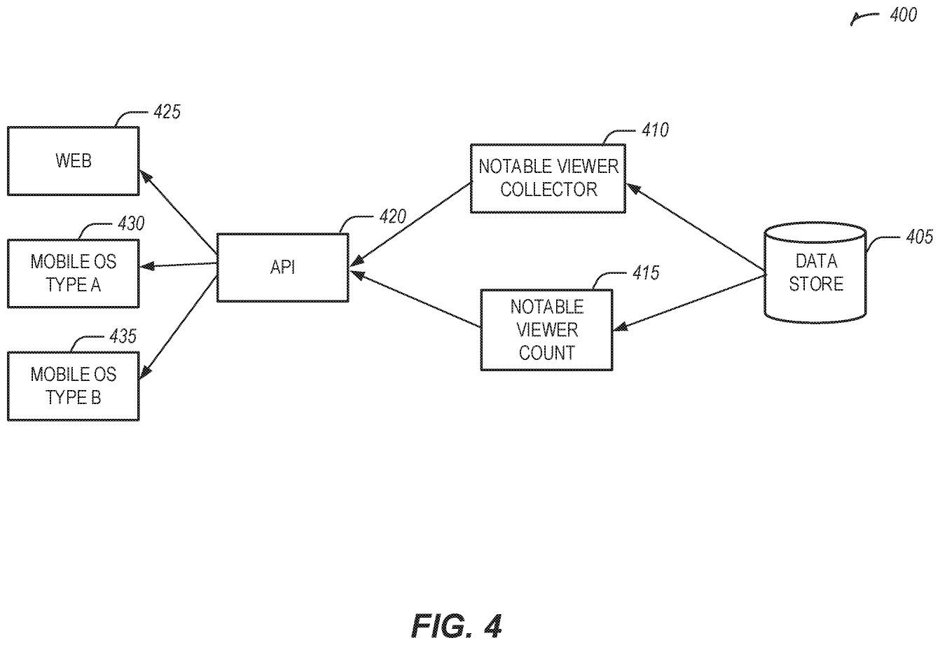

FIG. 4 illustrates an example of the process 400 of providing notable viewer data to a computing device for a member, in accordance with some embodiments. When the social networking service receives a request from a member for the viewers of their profile, a notable viewer collector 410 retrieves the notable viewer data from the data store 405. The notable viewer count 415 retrieves the total number of notable viewers for the member from the data store 405.

The notable viewer collector 410 and notable viewer count 415 provide notable viewer data to the API 420. The API 420 provides an interface with the notable viewer data to the member's computing device. The API 420 formats the interface for the appropriate platform of the computing device. This may include a web browser interface 425, an application for a mobile device operating system (OS) of type A 430, or an application for device mobile device OS of type B 435.

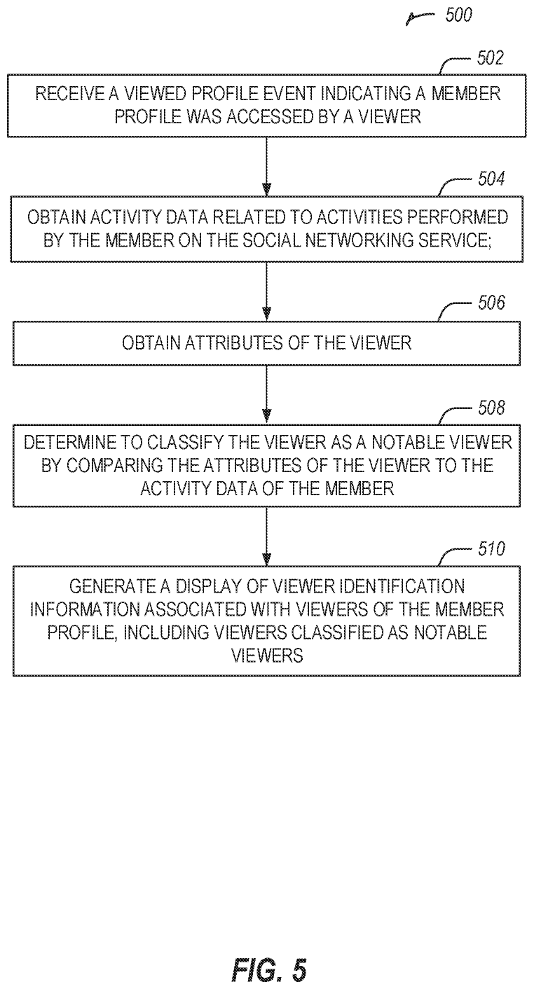

FIG. 5 illustrates a flowchart showing a technique 500 for determining a notable viewer of a member profile in a social networking service, in accordance with some embodiments. The technique 500 includes an operation 502 to receive a viewed profile event indicating a member profile was accessed by a viewer. The viewed profile event includes a member identification associated the member profile and a viewer identification associated with the viewer.

The technique 500 includes an operation 504 to obtain, using the member identification, activity data related to activities performed by the member on the social networking service. The activity data may include jobs the member has applied for, jobs the member has saved, and companies the member follows on the social networking service.

The technique 500 includes an operation 506 to obtain, using the viewer identification, attributes of the viewer. The attributes of the viewer may include job history, current employment position, and industry of current employment. Attributes of the viewer may include if the viewer is a recruiter or hiring manager, and the company the viewer is employed. The at ibutes of the viewer may include a set of job postings the viewer is associated with, such as being the job poster, the recruiter, or the hiring manager for a job posting.

The technique 500 includes an operation 508 to determine the viewer is a notable viewer by comparing the attributes of the viewer to the activity data of the member. The technique 500 may further include operations to calculate a score for the viewer. The score may be based on the activity data of the member and a similar attribute of the viewer. The technique 500 may further include operations to determine the viewer is a notable viewer if the score exceeds a predetermined threshold.

The technique 500 includes an operation 510 to generate a graphical user interface to display viewer identification information associated with viewers of the member profile. The viewers of the member profile may include viewers classified as notable viewers. The notable viewers may be listed first or have graphical decorations to indicate that the viewer is a notable viewer. The graphical user interface may include an interface item to facilitate a communication between the member and the notable viewer. Communication functions may include sending an email to the viewer, sending a text message to the viewer, or connecting to the viewer through the social networking service.

The technique 500 may further include operations to display an attribute of interest with the viewer identification information of the notable viewer in the graphical user interface. An attribute of interest may be any information that could be significant to the member. This may be the primary factor that was used to determine the viewer was a notable viewer. In many scenarios, an attribute of interest may be the relation the viewer has to job the member applied for. For example, if the viewer is the hiring manager for the job. An attribute of interest may be any attributes the member and the viewer have in common, such as attending the same college, enjoying the same hobby, or having similar connections in the social networking service. The technique 500 may further include operations to determine an attribute of interest by comparing the attributes of the viewer to the activity data of the member.

The technique 500 may further include operations to obtain a viewer connection set. The viewer connection set is members of the social networking service the viewer has a connection. The technique 500 may further include operations to obtain a member connection set. The member connection set is members of the social networking service the member has a connection. The technique 500 may further include operations to compare the member connection set to the viewer connection set to determine a shared connection set of members of the social networking service the member and the viewer share a connection. The technique 500 may further include operations to display members of the shared connection set with the viewer identification information of the notable viewer in the graphical user interface. For example, the notable viewer information may include a highlight of the people in the shared connection set to provide the member with people both the viewer and the member are associated with and may help make a connection between the member and the viewer.

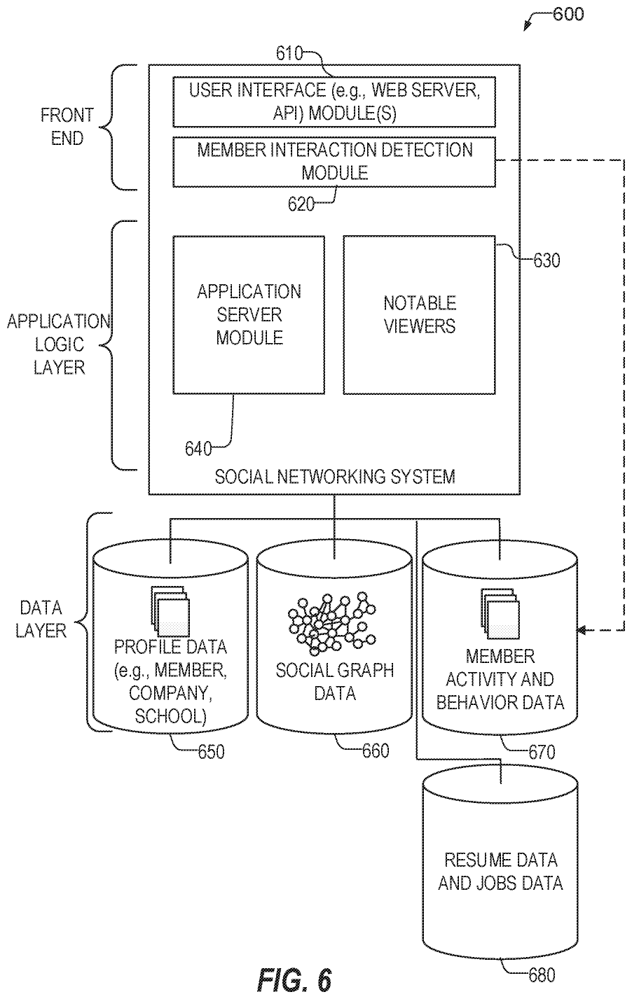

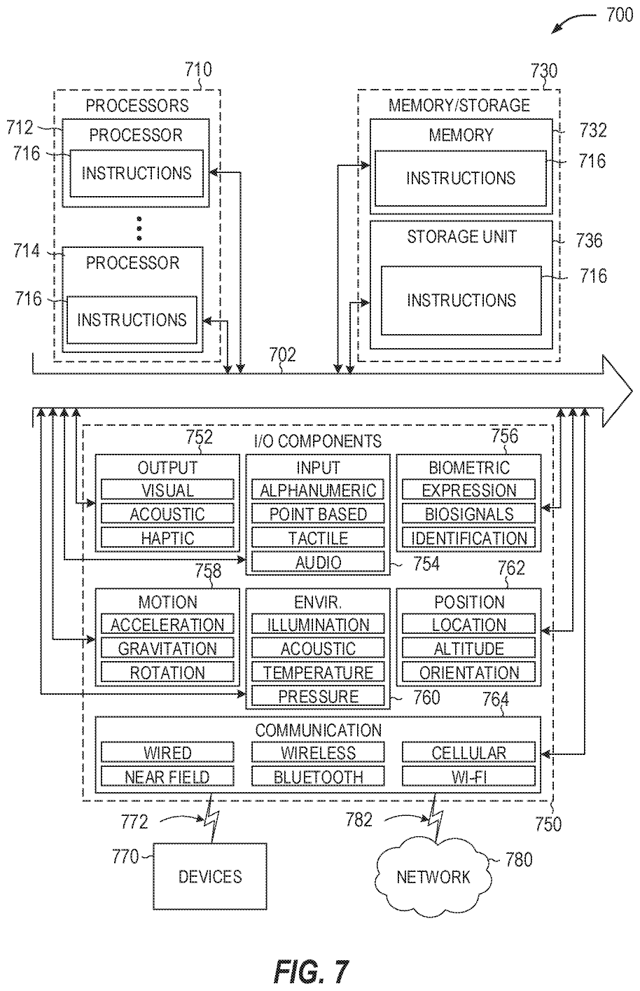

FIG. 6 is a block diagram showing the functional components of a social networking service 600. As shown in FIG. 6, a front end may comprise a user interface module (e.g., a web server) 610, which receives requests from various client-computing devices, and communicates appropriate responses to the requesting client devices. For example, the user interface module(s) 610 may receive requests in the form of Hypertext Transport Protocol (HTTP) requests, or other network-based, application programming interface (API) requests (e.g., from a dedicated social networking service application running on a client device). In addition, a member interaction and detection module 620 may be provided to detect various interactions that members have with different applications, services and content presented. As shown in FIG. 7, upon detecting a particular interaction, the member interaction and detection module 620 logs the interaction, including the type of interaction and any meta-data relating to the interaction, in the member activity and behavior database 670.

An application logic layer may include one or more various application server modules 640, which, in conjunction with the user interface module(s) 610, generate various graphical user interfaces (e.g., web pages) with data retrieved from various data sources in the data layer. With some embodiments, application server module 640 is used to implement the functionality associated with various applications or services provided by the social networking service as discussed above. Application layer may include notable viewers 630 which may determine notable viewers as described herein. For example, notable viewers 630 may implement the method of FIG. 5, and may determine notable viewers such as shown in FIGS. 1-4.

The data layer may include one or more data storage entities or databases such as profile database 650 for storing profile data, including both member profile attributes as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse or family members, educational background (e.g., schools, majors, matriculation or graduation dates, etc.), employment history, skills, professional organizations, and so on. This information is stored, for example, in the profile database 650. Similarly, when a representative of an organization initially registers the organization with the social networking service, the representative may be prompted to provide certain information about the organization. This information may be stored, for example, in the profile database 650, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members, or with other entities and objects are stored and maintained within a social graph in the social graph database 660. Also, as members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 6 by the member activity and behavior database 670. Information on job postings, job title information, context information, and résumé templates may be stored in résumé data and jobs data 680

With some embodiments, the social networking service 600 provides an application programming interface (API) module with the user interface module 610 via which applications and services can access various data and services provided or maintained by the social networking service. For example, using an API, an application may be able to request or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

FIG. 7 is a block diagram illustrating components of a machine 700 which according to some example embodiments is able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. The instructions 716 transform the general, non-programmed machine into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, PC, a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory/storage 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated. Circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732. store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of the processors 710 are examples of machine-readable media.

As used herein, “machine-readable medium” means a device able to store instructions (e.g., instructions 716) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine (e.g., processors 710), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. For example, in addition to a speaker, the output components 752 may include a visual output device adapted to provide augmented visual colors, animations, and presentation of information that is determined to best communicate and improve the user's mood to an optimal state as described herein. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure bio-signals (e.g., blood pressure, heart rate, body temperature, perspiration, or brain waves), measure exercise-related metrics (e.g., distance moved, speed of movement, or time spent exercising) identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or other suitable device to interface with the network 780. In further examples, the communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include Radio Frequency Identification (RFID) tag reader components, NFC smart tag detection components, optical reader components, or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

In various example embodiments, one or more portions of the network 780 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 7G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

Example 1 is a method for determining a notable viewer of a member profile in a social networking service, the method comprising: receiving a viewed profile event indicating a member profile was accessed by a viewer, wherein the viewed profile event includes, a member identification associated the member profile and a viewer identification associated with the viewer; obtaining, using the member identification, activity data related to activities performed by the member on the social networking service; obtaining, using the viewer identification, attributes of the viewer; determining the viewer is a notable viewer by comparing the attributes of the viewer to the activity data of the member; and generating a graphical user interface to display viewer identification information associated with viewers of the member profile, including viewers classified as notable viewers.

In Example 2, the subject matter of Example 1 includes, wherein determining to classify the viewer as a notable viewer further comprises: calculating a score based on the activity data of the member and a similar attribute of the viewer; and determining the viewer is a notable viewer if the score exceeds a predetermined threshold.

In Example 3, the subject matter of Examples 1-2 includes, determining, based on comparing the attributes of the viewer to the activity data of the member, an attribute of interest for the notable viewer; and displaying the attribute of interest with the viewer identification information of the notable viewer in the graphical user interface.

In Example 4, the subject matter of Examples 1-3 includes, wherein activity data includes jobs the member has applied for, jobs the member has saved, and companies the member follows on the social networking service.

In Example 5, the subject matter of Examples 1-4 includes, wherein attributes of the viewer include job history, current employment position, and industry of current employment.

In Example 6, the subject matter of Examples 1-5 includes, obtaining a viewer connection set, wherein the viewer connection set is members of the social networking service the viewer has a connection; obtaining a member connection set, wherein the member connection set is members of the social networking service the member has a connection; comparing the member connection set to the viewer connection set to determine a shared connection set of members of the social networking service the member and the viewer share a connection; and displaying members of the shared connection set with the viewer identification information of the notable viewer in the graphical user interface.

In Example 7, the subject matter of Examples 1-6 includes, wherein the graphical user interface includes an interface item to facilitate a communication between the member and the notable viewer.

Example 8 is a system for determining a notable viewer of a member profile in a social networking service comprising: at least one processor; and memory including instructions that, when executed by the at lest one processor, cause the at least one processor to: receive a viewed profile event indicating a member profile was accessed by a viewer, wherein the viewed profile event includes, a member identification associated the member profile and a viewer identification associated with the viewer; obtain, using the member identification, activity data related to activities performed by the member on the social networking service; obtain, using the viewer identification, attributes of the viewer; determine the viewer is a notable viewer by comparing the attributes of the viewer to the activity data of the member; and generate a graphical user interface to display viewer identification information associated with viewers of the member profile, including viewers classified as notable viewers.

In Example 9, the subject matter of Example 8 includes, wherein determining to classify the viewer as a notable viewer further comprising instruction to: calculate a score based on the activity data of the member and a similar attribute of the viewer; and determine the viewer is a notable viewer if the score exceeds a predetermined threshold.

In Example 10, the subject matter of Examples 8-9 includes, instruction to: determine, based on comparing the attributes of the viewer to the activity data of the member, an attribute of interest for the notable viewer; and display the attribute of interest with the viewer identification information of the notable viewer in the graphical user interface.

In Example 11, the subject matter of Examples 8-10 includes, wherein activity data includes jobs the member has applied for, jobs the member has saved, and companies the member follows on the social networking service.

In Example 12, the subject matter of Examples 8-11 includes, wherein attributes of the viewer include job history, current employment position, and industry of current employment.

In Example 13, the subject matter of Examples 8-12 includes, instruction to: obtain a viewer connection set, wherein the viewer connection set is members of the social networking service the viewer has a connection; obtain a member connection set, wherein the member connection set is members of the social networking service the member has a connection; compare the member connection set to the viewer connection set to determine a shared connection set of members of the social networking service the member and the viewer share a connection; and display members of the shared connection set with the viewer identification information of the notable viewer in the graphical user interface.

In Example 14, the subject matter of Examples 8-13 includes, wherein the graphical user interface includes an interface item to facilitate a communication between the member and the notable viewer.

Example 15 is at least one non-transitory computer readable medium including instructions for determining a notable viewer of a member profile in a social networking service that when executed by at least one processor, cause the at least one processor to: receive a viewed profile event indicating a member profile was accessed by a viewer, wherein the viewed profile event includes, a member identification associated the member profile and a viewer identification associated with the viewer; obtain, using the member identification, activity data related to activities performed by the member on the social networking service; obtain, using the viewer identification, attributes of the viewer; determine the viewer is a notable viewer by comparing the attributes of the viewer to the activity data of the member; and generate a graphical user interface to display viewer identification information associated with viewers of the member profile, including viewers classified as notable viewers.

In Example 16, the subject matter of Example 15 includes, wherein determining to classify the viewer as a notable viewer further comprising instruction to: calculate a score based on the activity data of the member and a similar attribute of the viewer; and determine the viewer is a notable viewer if the score exceeds a predetermined threshold.

In Example 17, the subject matter of Examples 15-16 includes, instruction to: determine, based on comparing the attributes of the viewer to the activity data of the member, an attribute of interest for the notable viewer; and display the attribute of interest with the viewer identification information of the notable viewer in the graphical user interface.

In Example 18, the subject matter of Examples 15-17 includes, wherein activity data includes jobs the member has applied for, jobs the member has saved, and companies the member follows on the social networking service.

In Example 19, the subject matter of Examples 15-18 includes, wherein attributes of the viewer include job history, current employment position, and industry of current employment.

In Example 20, the subject matter of Examples 15-19 includes, instruction to: obtain a viewer connection set, wherein the viewer connection set is members of the social networking service the viewer has a connection; obtain a member connection set, wherein the member connection set is members of the social networking service the member has a connection; compare the member connection set to the viewer connection set to determine a shared connection set of members of the social networking service the member and the viewer share a connection; and display members of the shared connection set with the viewer identification information of the notable viewer in the graphical user interface.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method for determining a notable viewer of a member profile in an online service, the method comprising:
receiving a viewed profile event indicating a member profile was accessed by a viewer, wherein the viewed profile event includes a member identification associated with the member profile and a viewer identification associated with the viewer;
obtaining, using the member identification, activity data related to activities performed by the member on the online service;
obtaining, using the viewer identification, attributes of the viewer;
determining the viewer is a notable viewer by comparing the attributes of the viewer to the activity data of the member; and
generating a graphical user interface to display viewer identification information associated with viewers of the member profile, including the viewer classified as a notable viewer on the graphical user interface.

2. The method of claim 1, wherein determining to classify the viewer as a notable viewer further comprises:
calculating a score based on the activity data of the member and a similar attribute of the viewer; and
determining the viewer is a notable viewer if the score exceeds a predetermined threshold.

3. The method of claim 1, further comprising:
determining, based on comparing the attributes of the viewer to the activity data of the member, an attribute of interest for the notable viewer; and
displaying the attribute of interest with the viewer identification information of the notable viewer in the graphical user interface.

4. The method of claim 1, wherein activity data includes jobs the member has applied for, jobs the member has saved, and companies the member follows on the online service.

5. The method of claim 1, wherein attributes of the viewer include job history, current employment position, and industry of current employment.

6. The method of claim 1, further comprising:
obtaining a viewer connection set, wherein the viewer connection set is members of the online service the viewer has a connection;
obtaining a member connection set, wherein the member connection set is members of the online service the member has a connection;
comparing the member connection set to the viewer connection set to determine a shared connection set of members of the online service the member and the viewer share a connection; and
displaying members of the shared connection set with the viewer identification information of the notable viewer in the graphical user interface,

7. The method of claim 1, wherein the graphical user interface includes an interface item to facilitate a communication between the member and the notable viewer.

8. A system for determining a notable viewer of a member profile in an online service comprising:
at least one processor; and
memory including instructions that, when executed by the at lest one processor, cause the at least one processor to:
receive a viewed profile event indicating a member profile was accessed by a viewer, wherein the viewed profile event includes a member identification associated the member profile and a viewer identification associated with the viewer;
obtain, using the member identification, activity data related to activities performed by the member on the online service;
obtain, using the viewer identification, attributes of the viewer;
determine the viewer is a notable viewer by comparing the attributes of the viewer to the activity data of the member; and
generate a graphical user interface to display viewer identification information associated with viewers of the member profile, including the viewer classified as a notable viewer on the graphical user interface.

9. The system of claim 8, wherein determining to classify the viewer as a notable viewer further comprising instruction to:
calculate a score based on the activity data of the member and a similar attribute of the viewer; and
determine the viewer is a notable viewer if the score exceeds a predetermined threshold.

10. The system of claim 8, further comprising instruction to:
determine, based on comparing the attributes of the viewer to the activity data of the member, an attribute of interest for the notable viewer; and
display the attribute of interest with the viewer identification information of the notable viewer in the graphical user interface.

11. The system of claim 8, wherein activity data includes jobs the member has applied for, jobs the member has saved, and companies the member follows on the online service.

12. The system of claim 8, wherein attributes of the viewer include job history, current employment position, and industry of current employment.

13. The system of claim 8, further comprising instruction to:
obtain a viewer connection set, wherein the viewer connection set is members of the online service the viewer has a connection;
obtain a member connection set, wherein the member connection set is members of the online service the member has a connection;
compare the member connection set to the viewer connection set to determine a shared connection set of members of the online service the memberd the viewer share a connection; and
display members of the shared connection set with the viewer identification information of the notable viewer in the graphical user interface.

14. The system of claim 8, wherein the graphical user interface includes an interface item to facilitate a communication between the member and the notable viewer.

15. At least one non-transitory computer readable medium including instructions for determining a notable viewer of a member profile in an online service that when executed by at least one processor, cause the at least one processor to:
receive a viewed profile event indicating a member profile was accessed by a viewer, wherein the viewed profile event includes a member identification associated the member profile and a viewer identification associated with the viewer;
obtain, using the member identification, activity data related to activities performed by the member on the online service;
obtain, using the viewer identification, attributes of the viewer;
determine the viewer is a notable viewer by comparing the attributes of the viewer to the activity data of the member; and
generate a graphical user interface to display viewer identification information associated with viewers of the member profile, including the viewer classified as a notable viewer on the graphical user interface.

16. The at least one computer readable medium of claim 15, wherein determining to classify the viewer as a notable viewer further comprising instruction to:
calculate a score based on the activity data of the member and a similar attribute of the viewer; and
determine the viewer is a notable viewer if the score exceeds a predetermined threshold.

17. The at least one computer readable medium of claim 15, further comprising instruction to:
determine, based on comparing the attributes of the viewer to the activity data of the member, an attribute of interest for the notable viewer; and
display the attribute of interest with the viewer identification information of the notable viewer in the graphical user interface.

18. The at least one computer readable medium of claim 15, wherein activity data includes jobs the member has applied for, jobs the member has saved, and companies the member follows on the online service.

19. The at least one computer readable medium of claim 15, wherein attributes of the viewer include job history, current employment position, and industry of current employment.

20. The at least one computer readable medium of claim 15, further comprising instruction to:
obtain a viewer connection set, wherein the viewer connection set is members of the online service the viewer has a connection;
obtain a member connection set, wherein the member connection set is members of the online service the member has a connection;
compare the member connection set to the viewer connection set to determine a shared connection set of members of the online service the member and the viewer share a connection; and
display members of the shared connection set with the viewer identification information of the notable viewer in the graphical user interface.
